(19) United States
(12) Patent Application Publication
(10) Pub. No.: US 2007/0112524 A1
(43) Pub. Date: May 17, 2007

(54) Correlation of DNA/amino acid sequences

(75) Inventors: James Herbert King, Suncook, NH (US); John William King, Suncook, NH (US)

Correspondence Address: JAMES H. KING, P.O. BOX 5, SUNCOOK, NH, 03275, US

(73) Assignee: JAMES H. KING

(21) Appl. No.: 11/036,270

(22) Filed: Sep. 30, 2005

Related U.S. Application Data
(60) Provisional application No. 60/481,913.

(51) Int. Cl. G06F 19/00

(52) U.S. Cl. 702/19; 702/20

(57) ABSTRACT

This program is one of many approaches to correlating nucleotides, amino acids or any biophysical parameter in quantum biology. The output is a correlation coefficient and the innovative result is the quanification of any biomolecular sequence. This reading frame distance approach is the most important of all, as it gives a quantity to intronic sequences which regulate all exonic sequences. Amino acids can be correlated as parameters for they give a nice statistical distribution as there are twenty of them. By transposing the matrix of numbers produced by this program, one can obtain the relative significance of each sequence position for any variable such as malaria, dengue fever, etc. This QBASIC, DOS approach is valuable for Africa and LDC's as they do not have to update their old PC's. It can be written in any modern language and used by any industrialized nation.

The main idea is to use biochemical parameter values to quantify and to correlate DNA/amino acid sequences. The biochemical parameters eg, mutability, molecular weight, hydrophobicity, polarity, PkN, PkC, beta sheet probability, alpha helix probability, energy per residue, energy per atom, bulkiness, contribution of side chain to molecular weight, hydrophobicity, propensity for gaps, reading frame distance and other parameters to be added later, are quantified in order to correlate these DNA/amino acid values from species to species or from healthy cell to diseased cell (cancer patient to remission patient or from diabetes patient to obese non-diabetes patient etc.) to find significant, causal associations. The correlations can be run between two species to check for taxonomic or evolutionary association.

The correlations used would be PEARSONIAN as the data consisting of continuous, normally-distributed, biochemical parameter values would be suitable for non-discrete correlation model building. This idea has never been carried out and is statistically unique.

The flow chart begins with the introduction of the alphabetical letters for DNA/amino acids and ends with their quantification into biochemical parameters (hydrophobicity rating or polarity measurement etc.) and the application of the PEARSONIAN CORRELATION FORMULA for the calculation of the correlation coefficient:
1.) Use any language e.g. C++, VB.net etc.
2.) Introduce two files of sequence letters for a bivariate correlation.
3.) Do until END OF FILE.
4.) Assign the biochemical parameter value to each letter in file #1.
5.) Now assign a corresponding value to each letter in file #2.
6.) Do until END OF FILE.
7.) Use input command for entering data by hand.
8.) Input a value for each range desired from each of the two files e.g. 1,4 2,5 or whatever range one wants to correlate.
9.) Next, sum the parameter values in each of the two ranges.
10.) Divide the sum by the range value (example above would equal 4 in each file).
11.) Multiply each deviation from the mean value found in file 1 by each deviation found in file 2.
12.) Sum this deviation value and divide by n−1. This is the covariance.
13.) Divide this deviation sum from above by standard deviation of file one times standard deviation of file two.
14.) PRINT this as the correlation coefficient.

1. We have invented a machine process which allows biological researchers to correlate dna and amino acid sequences by quantifying the nucleotides or groups of nucleotides, amino acids or groups of amino acids which are called words, with each other or with any other measured variable.
Our invention is unique in that it allows biological researchers to improve upon the current system of matching letters from sequence to sequence and then calculating a percentage match.
The letter matching system can give erroneous answers as the importance of being exact about where the nucleotide or grouped nucleotide word is located in each sequence, or the exact characteristic of each amino acid or grouped amino acid word is located in the sequence, is much more significant than simply knowing how many nucleotides or amino acids are the same between each sequence as is currently done.
Our invention corrects the error of letter matching which percentages as different two different amino acids yet they are actually the same to the sequence as they exhibit the same biophysical characteristic such as hydrophobicity or polarity, etc.
The machine uses any mouse or keyboard as the input device, any computer for a data receiving and calculating device and any computer screen or printer for an output device.
The machines must be compatible.
The instructions for the entire machine process can be written in any computer language as long as it is compatible with the machine system being used.
Finally and most importantly the machine uses the input values to assign a quantity to each nucleotide or amino acid, or groups of same called words, which no one has been able to do in a machine system before, in order to correlate these sequence positions with any measured biological or disease variable.
The invention is unique in that it allows the speedy processing of biological sequence correlations by using the massive biological sequence libraries currently available.
This machine process is unique and extremely important as biological scientists will now be able to go beyond mere letter matching and percentages into the world of higher level correlation mathematics and model building.
